(19) United States
(12) Patent Application Publication
(10) Pub. No.: US 2009/0144527 A1
(43) Pub. Date: Jun. 4, 2009

(54) STREAM PROCESSING APPARATUS, METHOD FOR STREAM PROCESSING AND DATA PROCESSING SYSTEM

(76) Inventors: Hiroaki NAKATA, Yokohama (JP); Takafumi YUASA, Musashino (JP); Fumitaka IZUHARA, Kokubunji (JP); Kazushi AKIE, Kokubunji (JP); Motoki KIMURA, Tachikawa (JP)

Correspondence Address: MATTINGLY & MALUR, P.C., 1800 DIAGONAL ROAD, SUITE 370, ALEXANDRIA, VA, 22314, US

(21) Appl. No.: 12/324,951

(22) Filed: Nov. 28, 2008

(30) Foreign Application Priority Data
Nov. 29, 2007 (JP) 2007-308347

(51) Int. Cl. G06F 9/44

(52) U.S. Cl. 712/221

(57) ABSTRACT

The present invention provides a stream processing apparatus capable of improving the processing performance in the case of continuously processing a plurality of data streams. A control stream, different from a data stream, is prepared, and a program and a parameter are updated in advance in accordance with the control stream. Double buffer areas are prepared in a memory of the stream processing apparatus into which the program and the parameter are stored. The location of the data stream to be input is written in the control stream, and buffers for reading the data stream are multiplexed so as to read in advance the top portion of the data stream to be processed next.

### CLAIM OF PRIORITY

The Present application claims priority from Japanese application JP2007-308347 filed on Nov. 29, 2007, the content of which is hereby incorporated by reference into this application.

### FIELD OF THE INVENTION

The present invention relates to a technique of a stream process in which a data string is processed.

### BACKGROUND OF THE INVENTION

Patent Document 1 discloses a method as a related art according to the present invention. The Patent Document 1 describes an apparatus for realizing rewriting of program/data sets in an instruction memory and a data memory of a processor in accordance with a request from the processor in a data stream processing unit.

[Patent Document 1] Japanese Unexamined patent Publication No. 2004-179809

### SUMMARY OF THE INVENTION

In the case where a plurality of data streams are continuously processed, if the time required from completion of processing one data stream to starting of processing the next data stream is long, the time is waste, and thus, the effective performance of a stream processing apparatus is deteriorated. In the case where a processor is used in a data stream process in the stream processing apparatus, if most of programs used for the data stream process differ from each other, or necessary parameters largely differ from each other, it takes a long time until these programs and parameters are available for use in the stream processing apparatus prior to starting of each data stream process, which largely affects on the performance. In addition, in the case where the streams are stored in an external memory, it takes time until an initial part of the streams is read from the memory when starting a new stream process, and the operation of the stream processing apparatus is stopped during the time. This fact largely affects on the performance especially when the streams are frequently switched.

An object of the present invention is to improve the processing performance in the case where a plurality of data streams are continuously processed.

The above-described and the other objects and novel characteristics of the present invention will be apparent from the description of the present specification and the accompanying drawings.

Summarized description of the representative outlines of the present invention disclosed in the application is as follows.

Specifically, a control stream, different from a data stream, is prepared for control, a rewriting process of a program and a parameter held by a memory that is accessible by a processor for a stream process at a high speed in accordance with the control stream is performed prior to a data stream process. In other words, a data transfer control apparatus controls data transfer of the data stream and the control stream between the outside of the data transfer control apparatus and the buffer memory in parallel to an arithmetic process performed by the processor for the data stream in a buffer memory.

Summarized description of effects obtained by the representative aspects of the present invention disclosed in the application is as follows.

Specifically, during a data stream process in a processor which performs a stream process, the entire or an initial part of the data stream to be processed next can be prepared in advance in an embedded memory accessible by the processor for performing a data stream process at a high speed. In addition, even in the case where different processing contents and different processing parameters for each data stream are necessary, necessary programs and parameters can be prepared in advance in the embedded memory accessible by the processor for performing the data stream process at a high speed by the control stream. Accordingly, in the case where a plurality of data streams are continuously processed, it is possible to reduce a waiting time of the processor for performing the data stream process during a transition period between one stream process and the next stream process, and to enhance the effective performance of the stream processing apparatus.

### BRIEF DESCRIPTION OF THE DRAWINGS

FIG. 1 is a block diagram showing a first example of a stream input/output configuration of a stream processing apparatus;

FIG. 2 is a block diagram showing an example of a data processing system to which the stream processing apparatus is applied;

FIG. 3 is an explanatory diagram for exemplifying address mapping of a memory when accessing from a bus;

FIG. 4 is an explanatory diagram for exemplifying address mapping of the stream processing apparatus when accessing from the bus;

FIG. 5 is an explanatory diagram for exemplifying a configuration of a DMA control register;

FIG. 6 is an explanatory diagram for exemplifying a configuration of a status flag register of a DMA register set;

FIG. 7 is an explanatory diagram for exemplifying address mapping when accessing from a stream processing processor to a program;

FIG. 8 is an explanatory diagram for exemplifying address mapping when accessing from the stream processing processor to data;

FIG. 9 is an explanatory diagram for exemplifying the content of address conversion when accessing to a first buffer map area;

FIG. 10 is an explanatory diagram for exemplifying a configuration of a control stream;

FIG. 11 is an explanatory diagram for exemplifying a field configuration of a control command header;

FIG.12 is an explanatory diagram for exemplifying relations between command types and functions of the control command of the stream processing apparatus;

FIG. 13 is an explanatory diagram for exemplifying a configuration of the control command of a command type 0;

FIG. 14 is an explanatory diagram for exemplifying a configuration of the control command of a command type 1;

FIG. 15 is an explanatory diagram for exemplifying a configuration of the control command of a command type 4;

FIG. 16 is a timing chart for exemplifying operational timing of the stream processing apparatus;

FIG. 17 is an explanatory diagram for exemplifying a stream input/output configuration of the stream processing apparatus whose function is extended by a sub-control stream;

FIG. 18 is an explanatory diagram for exemplifying relations between command types and functions of the control command in the stream processing apparatus using the sub-control stream; and

FIG. 19 is an explanatory diagram for exemplifying a configuration of the control command of a command type 2.

### DETAILED DESCRIPTION OF THE PREFERRED EMBODIMENTS

### 1. Outline of the Embodiment

First of all, the outlines of the representative embodiments of the present invention disclosed in this application will be described first. It should be noted that parenthetic reference numerals of the drawings which are referred to in the outlined description for the representative embodiments merely exemplify constituent elements included in the concept of the constituent elements to which the reference numerals are given.
[1] A stream processing apparatus which inputs a data stream to perform an arithmetic process and outputs the result as a data stream, the stream processing apparatus including: a buffer memory (130) ; and a processor (180), wherein information necessary for a stream process is input to the buffer memory as a control stream, the control stream contains information on where to obtain the data stream to be input and a parameter necessary for the arithmetic process of the data stream, the data stream is input to the buffer memory in accordance with the information on where to obtain the data stream, and the processor performs the arithmetic process for the data stream input to the buffer memory on the basis of the parameter of the control stream.

According to this, during the data stream process by the processor, the entire or an initial part of the data stream to be processed next or necessary programs and parameters can be prepared in advance in the buffer memory or the like by the control stream. Accordingly, it is possible to reduce awaiting time of the processor for performing the data stream process during a transition period between one stream process and the next stream process, and to enhance the effective performance of the stream processing apparatus.
[2] The stream processing apparatus according to [1], including a transfer control apparatus (120) which transfers the control stream and the data stream to the buffer memory from the outside of the stream processing apparatus. The transfer control for these streams can be performed without placing a burden on the processor.
[3] The stream processing apparatus according to [2], including a control unit (150) which analyzes the control stream to obtain the parameter and the information on where to obtain the data stream, and sets transfer control conditions to the transfer control apparatus. The process on the basis of the control stream can be performed without placing a burden on the processor.
[4] The stream processing apparatus according to [3], including a data memory (170) to which the parameter is transferred and which is accessible by the processor. Even in the case where processing parameters that are different for each data stream are necessary, the necessary parameters can be prepared in the data memory in advance by the control parameter.
[5] The stream processing apparatus according to [4], wherein the control unit obtains information on an arithmetic procedure from the control stream, the stream processing apparatus includes an instruction memory (160) to which the obtained information on the arithmetic procedure is transferred and which is accessible by the processor, and the processor performs the arithmetic process using the information on the arithmetic procedure read from the instruction memory. Even in the case where arithmetic processing procedures that are different for each data stream are necessary, the necessary information of the arithmetic procedure can be prepared in the instruction memory in advance by the control parameter.
[6] The stream processing apparatus according to [4], wherein the control stream contains information on starting of a sub-control stream (706), the sub-control stream contains a parameter necessary for a process of the data stream, the control unit sets the transfer control conditions to the transfer control unit in accordance with the content of the control stream so as to transfer the sub-control stream to the buffer memory, and the processor performs the arithmetic process on the basis of the parameter of the sub-control stream transferred to the buffer. In the case where the same parameter is repeatedly used in different data stream processes, it is not necessary to include the same parameter each time in the respective control streams, which contributes to reduction in the data amount of the control stream, reduction in the capacity of the memory area, and reduction in data transfer time. It is advantageous to make faster the operating frequency of the stream processing apparatus.
[7] The stream processing apparatus according to [5], wherein the control stream contains information on starting of a sub-control stream, the sub-control stream contains the information on the arithmetic procedure necessary for a process of the data stream, the control unit sets the transfer control conditions to the transfer control unit in accordance with the content of the sub-control stream so as to transfer the sub-control stream to the buffer memory, and the processor performs the arithmetic process on the basis of the information of the arithmetic procedure transferred to the buffer. In the case where the same arithmetic procedure is repeatedly used in different data stream processes, it is not necessary to include the information of the same arithmetic procedure each time in the respective control streams, which contributes to reduction in the data amount of the control stream, reduction in the capacity of the memory area, and reduction in data transfer time. It is advantageous to make faster the operating frequency of the stream processing apparatus.
[8] The stream processing apparatus according to [1], wherein in a process of one input data stream, the result is output while being divided into a plurality of data streams. The processing content for the data stream is optional.
[9] The stream processing apparatus according to [1], referring to a plurality of input streams, performing the arithmetic process by referring to the input streams, and outputting the result of the arithmetic process. The processing content for the data stream is optional.
[10] The stream processing apparatus according to [1], wherein the processor performs a stream process in accordance with the arithmetic procedure, the buffer memory temporarily stores the input data stream and the data stream to be output, and the processor can randomly access the buffer memory. An access mode of the processor to the buffer memory is flexible.
[11] The stream processing apparatus according to [1], wherein the processor performs a stream process in accordance with the arithmetic procedure, the stream processing apparatus includes a data memory for storing data to be written or read by the processor, and the data memory can perform an address conversion process when being accessed from the processor. The address conversion is a process in which when a process of one data stream is completed and a process of the next data stream is started, logical addresses mapped to a memory area where one data stream is stored and a memory area where the other data stream is stored are switched to each other. The double-buffer configuration allows the control stream and the data stream for the next stream process to be stored in the buffer memory in advance without affecting on the stream process by the processor. The switching of the address mapping allows the program description executed by the processor to refer to the data memory to be not changed because the data to be referred to are located in either of the double buffers.
[12] The stream processing apparatus according to [1], wherein the processor performs a stream process in accordance with the arithmetic procedure, the stream processing apparatus includes an instruction memory for storing a program showing the arithmetic procedure of the processor. The instruction memory can perform an address conversion process when being accessed from the processor. The address conversion is a process in which when a process of one data stream is completed and a process of the next data stream is started, logical addresses mapped to a memory area where the program showing the arithmetic procedure for one data stream is stored and a memory area where the program showing the arithmetic procedure for the next data stream is stored are switched to each other. The same effect can be obtained in the storing area of the program showing the arithmetic procedure.
[13] A stream processing apparatus which inputs a data stream to perform an arithmetic process and outputs the result as a data stream, the stream processing apparatus including: a buffer memory; a data transfer control apparatus which is used for data transfer control between the buffer memory and the outside of the stream processing apparatus; and a processor which is used for an arithmetic process of the data stream stored in the buffer memory, wherein the data transfer control apparatus transfers the data stream to the buffer memory on the basis of information on where to obtain the data stream held by a control stream stored in the buffer memory, and the processor performs the arithmetic process for the data stream in the buffer memory on the basis of a parameter necessary for the arithmetic process of the data stream held by the control stream transferred to the buffer memory. The data transfer control apparatus controls data transfer of the data stream and the control stream between the outside of the data transfer control apparatus and the buffer memory in parallel to the arithmetic process by the processor for the data stream in the buffer memory.

According to this, the information of the parameter and the arithmetic procedure necessary for the process of the next data stream and the data stream are stored in the buffer memory in advance for use in parallel to the arithmetic process of the data stream. Accordingly, in the case where a plurality of data streams are continuously processed, it is possible to reduce a waiting time of the processor for performing the data stream process during a transition period between one stream process and the next stream process, and to enhance the effective performance of the stream processing apparatus.
[14] The stream processing apparatus according to [13], further including a control unit which performs control on the basis of an analysis result of the control stream stored in the buffer memory, wherein the control unit sets transfer conditions to the data transfer control apparatus on the basis of the information on where to obtain the data stream held by the control stream.
[15] The stream processing apparatus according to [13], further including a data memory into/from which data can be written or read by the processor, wherein the control unit sets a parameter necessary for the arithmetic process of the data stream held by the control stream to the data memory. It is possible to store the parameter and the like necessary for the next data stream process in the data memory in advance by using the control stream.
[16] The stream processing apparatus according to [13], further including a data memory into/from which data can be written or read by the processor, wherein the data memory can perform an address conversion process when being accessed from the processor, and the address conversion is a process in which when a process of one data stream is completed and a process of the next data stream is started, logical addresses mapped to a memory area where one data stream is stored and a memory area where the other data stream is stored are switched to each other.
[17] The stream processing apparatus according to [13], further including an instruction memory for storing a program showing the arithmetic procedure of the processor, wherein the instruction memory can perform an address conversion process when being accessed from the processor, and the address conversion is a process in which when a process of one data stream is completed and a process of the next data stream is started, logical addresses mapped to a memory area where the program showing the arithmetic procedure for one data stream is stored and a memory area where the program showing the arithmetic procedure for the next data stream is stored are switched to each other.
[18] A stream processing method in which an arithmetic process is performed for a data stream to output the result as a data stream includes a first step to a third step. The first step is a step of preparing, as information necessary for the stream process, information on where to obtain the data stream to be processed and one or more control streams each containing a parameter necessary for a process of the data stream. The second step is a step of referring to the data stream in accordance with the information on where to obtain the data stream of the prepared control stream. The third step is a step of performing an arithmetic process by referring to the parameter of the prepared control stream if needed.
[19] A data processing system including: a stream processing apparatus which inputs a data stream to perform an arithmetic process and outputs the result as a data stream; a memory in which a control stream and the data stream are stored as information necessary in a stream process for the data stream; and a host processor which controls the memory and the stream processing apparatus, wherein the control stream contains information on where to obtain the data stream to be input and a parameter necessary for the arithmetic process of the data stream, and the stream processing apparatus includes a buffer memory and a processor, inputs the control stream from the memory to the buffer memory, and inputs the data stream to the buffer memory in accordance with the information on where to obtain the data stream held by the input control stream, and the processor performs the arithmetic process for the data stream input to the buffer memory on the basis of the parameter of the control stream.
[20] The data processing system according to [19], wherein the host processor performs control to store the control stream and the data stream into the memory. The stream processing apparatus includes a transfer control apparatus which transfers the control stream and the data stream from the memory to the buffer memory.
[21] The data processing system according to [19], being formed on, for example, one semiconductor substrate as a semiconductor device.

### 2. Details of the Embodiment

The embodiment will be described in more detail. Hereinafter, the preferred embodiment of the present invention will be described in detail on the basis of the drawings. It should be noted that constituent elements having the same functions are given the same reference numerals throughout the all drawings for explaining the preferred embodiment of the present invention, and the explanations thereof will not be repeated.

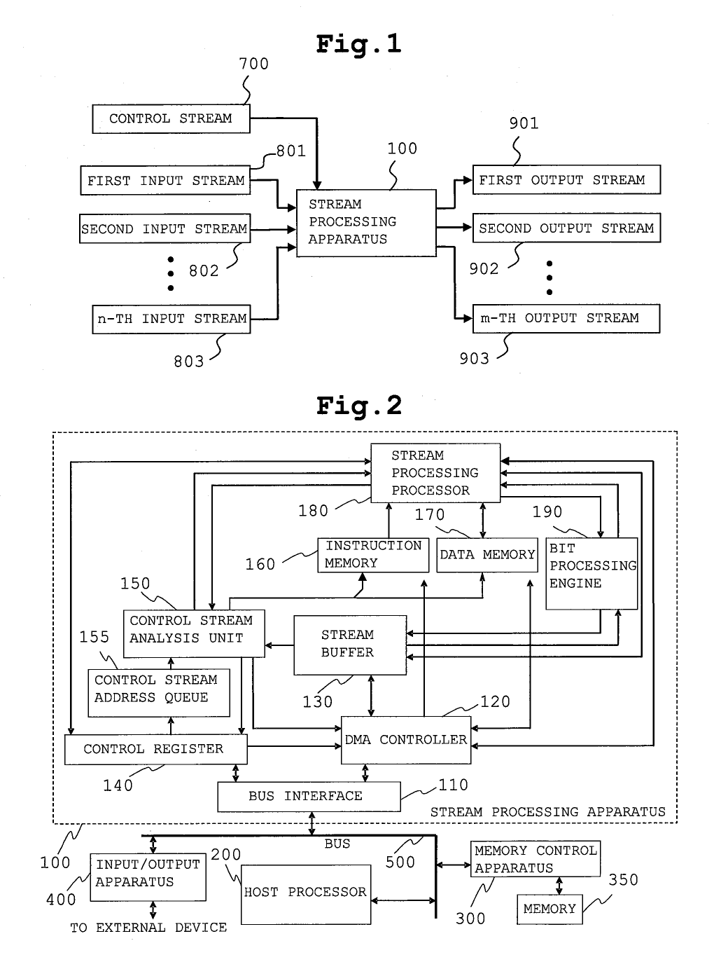

In FIG. 1, there is exemplified a configuration of input/output streams of a stream processing apparatus according to the present invention. As shown in FIG. 1, a stream processing apparatus 100 handles, as input and output streams, a control stream 700 that is an input of a control stream, in addition to a first input stream 801 to an n-th input stream 803 that are inputs of data streams and a first output stream 901 to an m-th output stream 903 that are outputs of data streams. Although a plurality of input streams and output streams are shown, there is a possibility of one input stream and one output stream, or either of one input stream and one output stream.

The stream processing apparatus 100 is capable of simultaneously referring to one or more input streams, and simultaneously outputting one or more output streams. The stream processing apparatus 100 refers to the control stream 700 independently from input/output processes of the input streams and the output streams.

In FIG. 2, there is exemplified a data processing system to which the stream processing apparatus 100 is applied. A system configuration will be described first. The stream processing apparatus 100 is coupled to a host processor 200, a memory control apparatus 300, a memory 350, and an input/output apparatus 400 via a bus 500.

The memory 350 serves as a main storage apparatus in the system configuration shown in FIG. 2. The host processor 200 controls the entire system, and also controls to serve as a trigger for using the stream processing apparatus 100. Programs necessary for the operation of the host processor 200 are stored in the memory 350, and the host processor 200 accesses the memory 350 via the memory control apparatus 300. The input/output apparatus 400 is used for coupling to the outside. Data from an external device are input from the input/output apparatus 400, and are processed after being stored once in the memory 350. A processing result of the data obtained by the stream processing apparatus 100 and the host processor 200 is stored once in the memory 350, and is output from the input/output apparatus 400 to the external device.

Next, an internal configuration of the stream processing apparatus 100 will be described. A bus interface 110 is an interface through which the bus 500 is coupled to the inside of the stream processing apparatus 100. A control register 140 is a register to which control information for controlling the entire operation of the stream processing apparatus 100 is set, and is accessible from the bus 500 side. The control register 140 is configured using a plurality of registers, if needed, in some cases.

A DMA controller 120 performs data transfer along with the input/output of the stream, and data transfer between an instruction memory 160 and the bus 500 side and between a data memory 170 and the bus 500 side. In addition, the DMA controller 120 has a function of bypass transfer of data, so that a direct access from the bus 500 side to the instruction memory 160 and the data memory 170 is possible. The host processor 200 and a control stream analysis unit set transfer control information to the DMA controller 120. In addition, a stream processing processor 180 can set the transfer control information to the DMA controller 120, and if needed in the stream process, the stream processing processor 180 can flexibly control the input/output of the stream.

A stream buffer 130 is a buffer memory that temporarily stores the content of the stream for the input/output processes. The control stream 700 is also temporarily stored in the stream buffer 130. When the stream is input or output, the DMA controller 120 transfers the stream between the stream buffer 130 and the bus 500 side.

The stream processing processor 180 is a processor that mainly processes the data stream, and operates in accordance with programs stored in the instruction memory 160. Further, the data memory 170 is arranged as a working data memory of the stream processing processor 180. The stream processing processor 180 detects that the data of the data stream are stored in the stream buffer 130, so that the stream processing processor 180 performs a predetermined data process (stream process) by reading the data from the stream buffer 130, and writes the result into the stream buffer.

A bit processing engine 190 provides functions of sequentially retrieving data from the data stream with a specified bit width and writing data into the data stream with a specified bit width. The bit processing engine 190 is utilized when the stream processing processor 180 handles continuous data having various bit lengths, and functions as a so-called accelerator. The bit processing engine 190 is coupled to the stream buffer 130, and can read or write the stream data from/into the stream buffer 130 all together in units such as 32 bits and 64 bits by which the bit processing engine 190 accesses the stream buffer 130.

A control stream address queue 155 is a FIFO buffer that holds an initial address at which the control stream 700 is stored via the control register 140. The control stream 700 is usually generated by the host processor 200 to be stored into the memory 350 prior to starting of the stream processing apparatus 100, and the stream processing apparatus 100 processes in accordance with the control stream 700. Accordingly, at the time of starting of the stream processing apparatus 100, the stream processing apparatus 100 needs an initial address indicating the location of the control stream 700 stored in the memory 350. The control stream analysis unit controls setting or starting of the DMA controller 120 in order to obtain the necessary control stream using such an address. Further, the control stream analysis unit 150 controls setting or starting of the DMA controller 120 or the stream processing processor 180 in accordance with the content of the control stream 700. Furthermore, the control stream analysis unit 150 also has a function of writing a part of the content of the control stream 700 into the instruction memory 160 or the data memory 170 if needed.

Here, the outline of a process using the control stream performed by the stream processing apparatus 100 will be described before describing below the details of the stream processing apparatus 100. The address of the memory 350 at which the control stream is stored is written into the control register 140 by the host processor 200, and the control stream analysis unit 150 initializes a control stream transfer channel of the DMA controller 120 using the address via the control stream address queue 155. The control stream is transferred to the stream buffer 130 in accordance with the initialization. The control stream analysis unit 150 analyzes the control stream transferred to the stream buffer 130, stores a parameter and the like accompanied by the control stream into the data memory 170, the instruction memory 160, or the like, and stores the data stream into the stream buffer 130 using the DMA controller 120 in accordance with address information specified in an input stream address field accompanied by the control stream. A group of streams include the control stream and the data stream corresponding to the control stream. When the data stream is input to the stream buffer 130, the stream processing processor 180 that executes the programs in the instruction memory 160 sequentially performs the stream process that is a predetermined data process, such as decoding, for the data of the data stream input to the stream buffer 130, and the processing result is stored into an area of the memory 350 specified by the control stream under the control of the DMA controller 120. Such a process is repeated for the streams comprised of a group of streams including the control stream and the data stream. Especially, when the stream processing processor 180 performs the stream process for the data stream of the streams composing a group of streams, the stream processing processor 180 inputs the control stream and the data stream composing the next group of streams in advance in parallel to the stream process. Specifically, during the stream process of the data stream performed by the stream processing processor 180, the stream processing processor 180 reads the control stream and the data stream of the streams composing the next group of streams in advance. The respective units of the stream processing apparatus 100 for realizing such a function will be described below in detail.

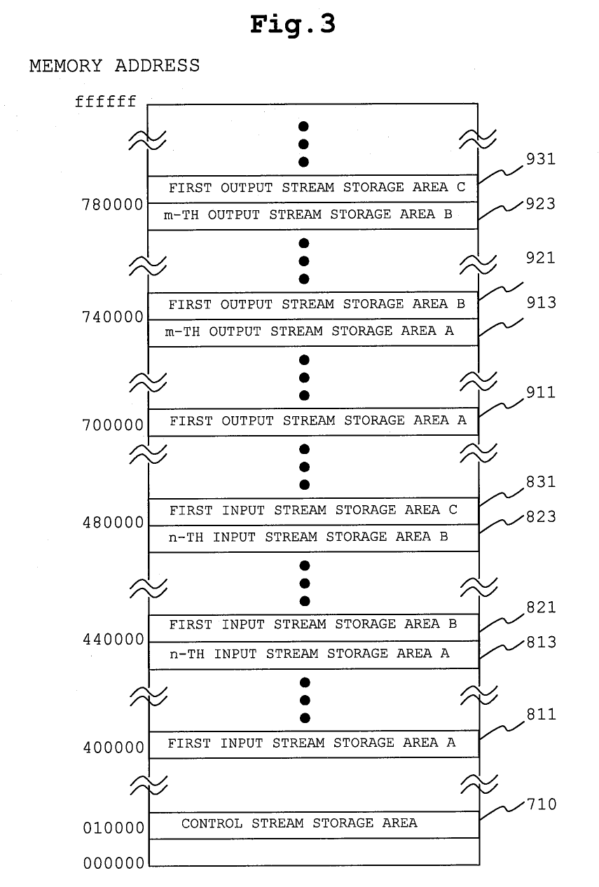

In FIG. 3, there is shown an example of area assignment when the streams handled by the stream processing apparatus 100 are stored into the memory 350. In FIG. 3, memory addresses are addresses used when accessing the memory 350 from the bus 500. Further, the memory addresses shown in FIG. 3 are examples, and may be changed in consideration of the system configuration and the programs of the host processor 200.

As input stream storage areas, there are representatively shown portions of areas A (area group A) including a first input stream storage area A811 to an n-th input stream storage area A813, portions of areas B (area group B) including a first input stream storage area B821 to an n-th input stream storage area B813, and a portion of an area C (area group C) including a first input stream storage area C831. However, necessary area groups of the input streams are present thereafter in the same manner in accordance with a system. The stream processing apparatus 100 has a function of simultaneously inputting a plurality of streams, and handles the input streams on an area group basis. If a plurality of area groups are prepared as input stream storage areas, the stream process can be continuously performed after various input streams are stored into a plurality of area groups.

Although the same number of input stream storage areas is prepared for each area group of the input streams, the number of input streams to be simultaneously referred to for each stream process may differ. In this case, the input stream storage areas left are unused.

As a matter of convenience, the explanation is given while the input stream storage areas to be simultaneously referred to for each area group are integrated. However, if the area management of the memory 350 is possible, it is not necessary to integrally arrange the input stream storage areas in one place. In addition, the number of input stream storage areas belonging to each area group can be dynamically managed, if needed.

At the time the stream processing apparatus 100 completes the process of the input streams stored in the input stream storage areas, the input stream storage areas are reused as stream areas for the streams that are newly input from the input/output apparatus 400.

Further, as output stream storage areas, there are representatively shown, in FIG. 3, portions of areas A (area group A) including a first output stream storage area A911 to an m-th output stream storage area A913, portions of areas B (area group B) including a first output stream storage area B921 to an m-th output stream storage area B913, and a portion of an area C (area group C) including a first output stream storage area C931. However, necessary area groups of the output streams are present thereafter in the same manner in accordance with a system. The stream processing apparatus 100 has a function of simultaneously outputting a plurality of streams in a stream process. By preparing a plurality of area groups of the output streams, results obtained by continuously performing the stream process can be stored without rewriting the previous results.

Although the same number of output stream storage areas is prepared for each area group of the output streams, the number of streams to be output for each stream process may be changed.

As a matter of convenience, an explanation is given while the output stream storage areas are integrated for each area group. However, if the area management of the memory 350 is possible, it is not necessary to integrally arrange the output stream storage areas in one place. In addition, the number of output stream storage areas belonging to each area group can be dynamically managed, if needed.

Results are written into the output stream storage areas from the stream processing apparatus 100 so that there is no possibility that new data are written from the stream processing apparatus 100 by outputting the results from the input/output apparatus 400. In addition, at the time the storage of the output results is not necessary, the output stream storage areas are reused as areas into which the stream processing apparatus 100 writes new results.

Into a control stream storage area 710, the control stream 700 to be passed to the stream processing apparatus when starting the stream processing apparatus 100 is stored. The control stream 700 is generated by the host processor 200. When a new data stream is input and the stream processing apparatus 100 is ready to process during a period the stream processing apparatus 100 is performing a process in accordance with one control stream 700, there arises the need for generating another control stream 700 to process the new data stream. In such a case, while the control stream storage area 710 is divided into a plurality of areas, the new control stream 700 is generated into another area so as not to rewrite the control stream 700 being currently used for the process.

When all the processes of one control stream 700 are completed, the control stream analysis unit 150 notifies the host processor 200 via the control register 140 and the bus interface 110. By using the notification, the host processor 200 determines whether or not it is possible to reuse the area into which the control stream 700 is stored.

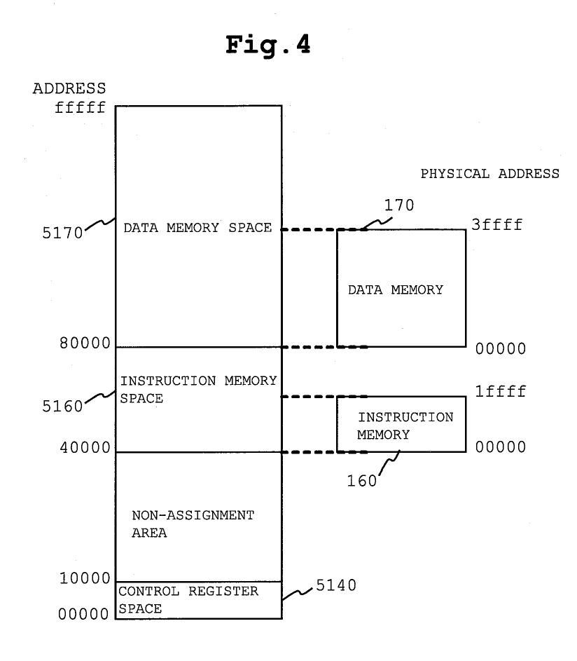

In FIG. 4, there are shown examples of address spaces when accessing the stream processing apparatus 100 from the bus 500 side. As address spaces, a control register space 5140, an instruction memory space 5160, and a data memory space 5170 are present.

Registers existing in the control register 140 and registers for DMA control existing in the DMA controller 120 are mapped in the control register space 5140, and the host processor 200 can control the stream processing apparatus 100 through these registers.

The instruction memory 160 is mapped in the instruction memory space 5160, and programs of the stream processing processor 180 can be written into the instruction memory space 5160 by the host processor 200 prior to the operation of the stream processing apparatus 100.

The data memory 170 is mapped in the data memory space 5170, and an initial parameter necessary for the stream processing apparatus 100 can be set to the data memory space 5170 by the host processor 200 prior to the operation of the stream processing apparatus 100.

In parts of the instruction memory space 5160 and the data memory space 5170, there exist spaces where actual memories are not mapped, so that the capacities of the instruction memory 160 and the data memory 170 can be extended.

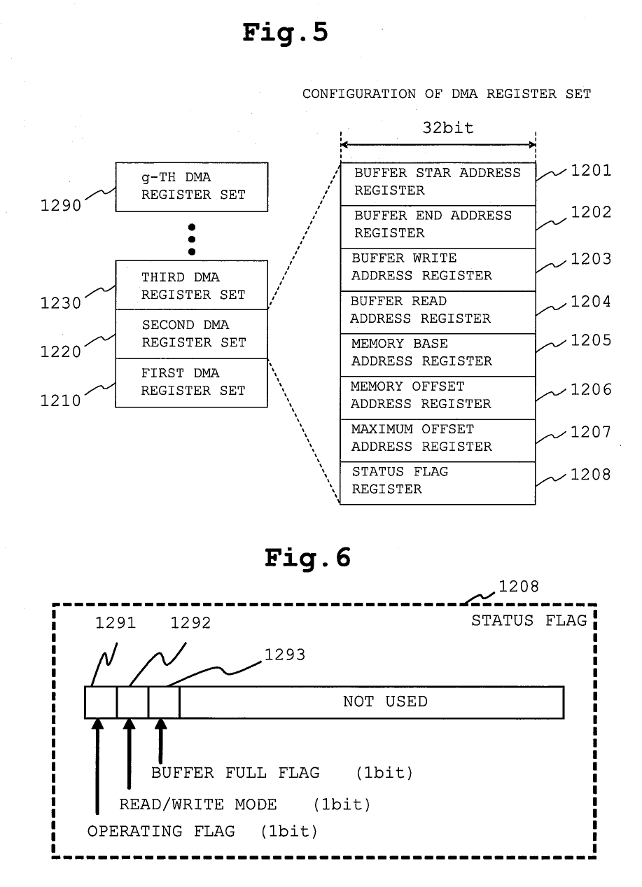

In FIG. 5, there is shown a configuration of the registers for DMA control existing in the DMA controller 120. The registers for DMA control include a plurality of register sets of a first DMA register set 1210 to a g-th DMA register set 1290. Each register set configures a DMA data transfer channel. Each register set includes a buffer start address register 1201, a buffer end address register 1202, a buffer write address register 1203, a buffer read address register 1204, a memory base address register 1205, a memory offset address register 1206, a maximum offset address register 1207, and a status flag register 1208. The registers 1201 to 1204 are registers for address specification on the stream buffer 130 side, and the registers 1205 to 1207 are registers for address specification on the memory 350 side. In other words, these registers are used for dual address transfer control between the stream buffer 130 and the memory 350, as will be described later.

The number of necessary DMA register sets is the maximum number of transfer streams or more that are possibly transferred by the DMA controller 120 at the same time. The number of necessary DMA register sets is calculated as follows. Specifically, “1” that is necessary for reading the control stream is added to the number obtained by doubling the sum of the maximum number of input streams that are possibly referred to at the same time when the stream processing apparatus 100 processes and the maximum number of streams that are possibly output at the same time when the stream processing apparatus 100 processes. The reason of necessity of the DMA register sets twice or more the sum of the maximum number of input streams that are possibly referred to at the same time and the maximum number of streams that are possibly output at the same time is to allow the input stream of the next processing target to be input in advance, and to allow an output of a processing result relating to the input stream to be processed next to start at the time the output stream that is a processing result relating to the current input stream is left in the stream buffer 130.

Degradation of the performance of the stream processing apparatus 100 caused by delay of starting the output of the output stream is usually smaller as compared to that caused by delay of reading the input stream. Accordingly, in consideration of the circuit size, it is conceivable that after the output stream that is a processing result relating to the current input stream is completely output from the stream buffer 130, setting of the DMA controller 120 necessary for output of a processing result relating to the next input stream to be processed is performed to start the output. In this case, the number of necessary DMA register sets is calculated as follows. Specifically, “1” that is necessary for reading the control stream is added to the sum of the number obtained by doubling the maximum number of input streams that are possibly referred to at the same time when the stream processing apparatus 100 processes and the maximum number of streams that are possibly output at the same time.

One DMA register set corresponds to one transfer channel for DMA transfer performed by the DMA controller 120. The buffer start address register 1201 holds the initial address of a storage area of the stream buffer 130 assigned to the corresponding transfer channel, and the buffer end address register 1202 holds an address just before the end address. The buffer write address register 1203 holds an address at which data are written into the buffer next, and the buffer read address register 1204 holds an address at which data are read from the buffer next, so that they are updated to indicate the next addresses for each of data writing and data reading. If the update allows the address to match the address held by the buffer end address register 1202, the address is restored to the address held by the buffer start address 1201.

The memory base address register 1205 holds the initial address of a source area or a destination area of the memory 350. The memory offset register 1206 holds difference between the next reading or writing address of the memory 350 and the value held by the memory base address register 1205. They are updated so as to indicate the next addresses every time reading or writing is performed on the corresponding transfer channel from/into the memory 350.

The maximum offset address register 1207 indicates the maximum allowable value held by the memory offset register 1206. In the case where the value of the memory offset register 1206 matches the maximum offset address register 1207, and then, a reading or writing process from/into the memory 350 occurs on the corresponding channel, the channel is stopped to notify the stream processing processor 180 and the host processor 200. This function can limit available areas of the memory 350 for each transfer channel of DMA, and realizes protection of the content of the memory 350.

The status flag register 1208 holds an operation status and a transfer direction of the corresponding transfer channel, and a buffer full status of an area assigned to the stream buffer 130.

In FIG. 6, there is exemplified a configuration of the status flag register. An operating flag 1291 indicates 1 when the corresponding transfer channel is being operated and 0 when the corresponding transfer channel is being stopped. The operating flag 1291 is set to 1 when transfer on the transfer channel is started. When the transfer on the transfer channel is completed, the DMA controller 120 automatically restores the value to 0. A read/write mode flag 1292 is set to 1 when transfer is performed on the corresponding transfer channel from the stream processing apparatus 100 to the memory 350, and 0 when transfer is performed on the corresponding transfer channel from the memory 350 to the stream processing apparatus 100. A buffer full flag 1293 is set to 1 when an area of the stream buffer 130 assigned to the corresponding channel is completely filled with active data, and is set to 1 otherwise. In the DMA transfer, if the content of the buffer write address register 1203 differs from that of the buffer read address register 1204, it can be surely found that active data are held in the stream buffer 130. However, if the content of the buffer write address register 1203 is the same as that of the buffer read address register 1204, it is conceivable that the buffer has no active data, or is completely filled with the active data. Accordingly, in order to determine in which status the buffer is, the buffer full flag 1293 is needed.

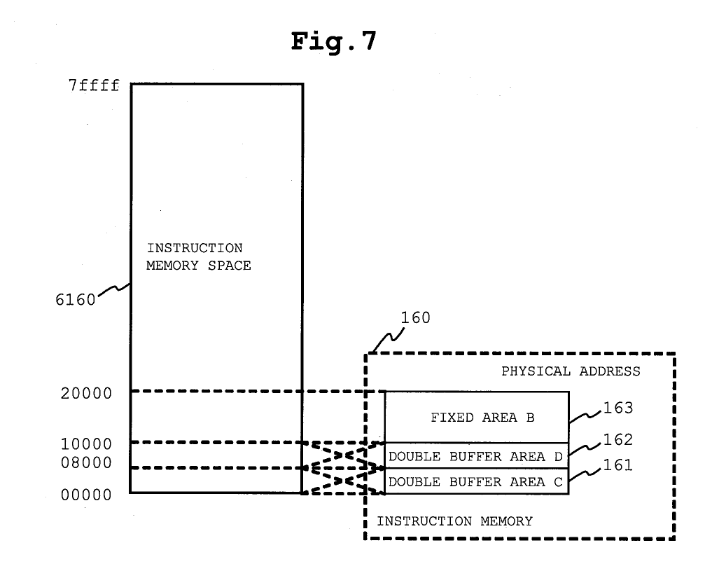

In FIG. 7, there is shown a configuration of an instruction memory space 6160 that is a memory space for reading a program of the stream processing processor 180. The instruction memory 160 is mapped only at a part of the instruction memory space 6160 in consideration of future extension. A double buffer area C161, a double buffer area D162, and a fixed area B163 are present in the instruction memory 160.

Address mapping to the instruction memory space 6160 is alternately switched between the double buffer area C161 and the double buffer area D162 every time a process of one data stream is completed by the stream processing processor 180. For example, on the condition that the double buffer area C161 is assigned to addresses 00000-08000 and the double buffer area D162 is assigned to addresses 08000-10000, when the stream processing processor 180 executes a program in the double buffer area C161 with the addresses 00000-08000, another program used for the next stream process is stored into the double buffer area D162 in advance. At the time the execution of the program in the double buffer area C161 is completed, the mapping of the double buffer area D162 is switched to the addresses 00000-08000 and the mapping of the double buffer area C161 is switched to the addresses 08000-10000, so that the stream processing processor 180 can execute the program in the double buffer area D162 in the next stream process with the addresses 00000-08000. As described above, if a program being used for a process of one data stream is stored in one of the areas, the content of the other area can be rewritten during the process of the data stream, the data stream process performed by the stream processing processor 180 and the writing process of a program for the next data stream process can be simultaneously performed. The fixed area B163 is an area into which a program (subroutine) commonly used for various data stream processes is stored. A logic for alternate switching of the address mapping is held by, for example, the instruction memory, and a switching instruction may be issued in accordance with the processing state of the control stream and the processing state of the stream processing processor 180. In addition, the fixed area B163 is not possibly present in some configuration, and when it is not necessary to replace a program for each data stream, the double buffer area C161 and the double buffer area D162 are not necessary.

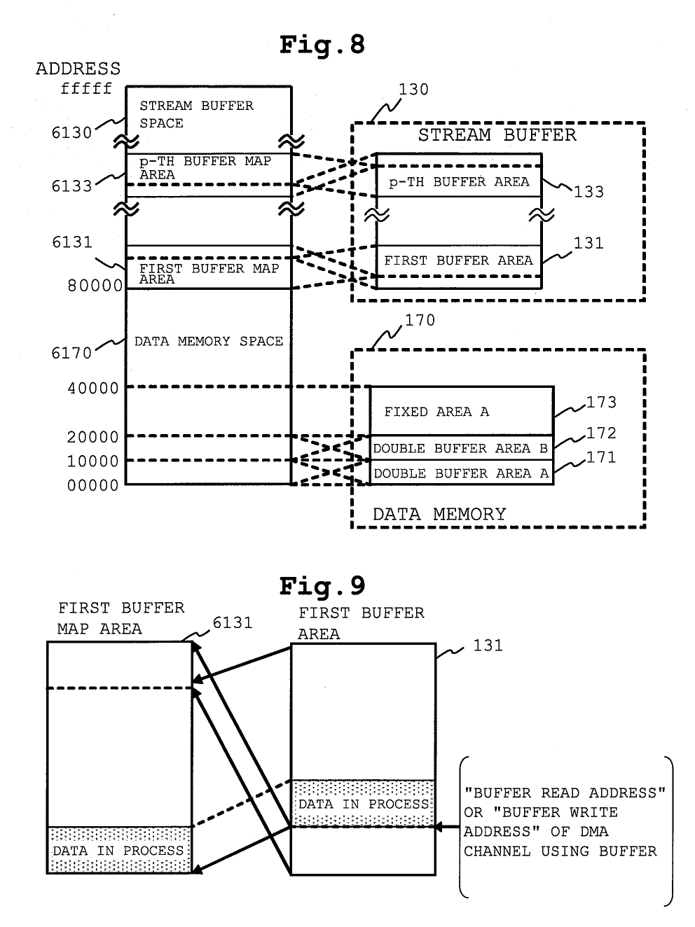

In FIG. 8, there is shown a configuration of a memory space for data reading/writing of the stream processing processor 180. A data memory space 6170 and a stream buffer space 6130 are present in the memory space for data reading/writing.

The data memory 170 is mapped only at a part of the data memory space 6170 in consideration of future extension. A double buffer area A171, a double buffer area B172, and a fixed area A173 are present in the data memory 170.

Address mapping to the data memory space 6170 is alternately switched between the double buffer area A171 and the double buffer area B172 every time a process of one data stream is completed by the stream processing processor 180. Accordingly, if a parameter being used for a process of one data stream is stored in one of the areas, the content of the other area can be rewritten during the process of the data stream, and the data stream process performed by the stream processing processor 180 and the writing of another parameter for the next data stream process can be simultaneously performed. The switching of the address mapping may be performed in the same manner as the case of the instruction memory 160.

The fixed area A173 is used as a working data memory necessary for various data stream processes. The fixed area A173 is not possibly present in some configuration, and when it is not necessary to replace a parameter for each data stream, the double buffer area A171 and the double buffer area B172 are not necessary.

The stream buffer 130 is mapped only at a part of the stream buffer space 6130 in consideration of future extension of the stream buffer 130. Although the size of the assigned buffer area is limited by mapping the stream buffer 130 to the memory space for data reading/writing of the stream processing processor 180, it is possible to randomly access the stream data within the range. A bunch of data are locally present in some cases, so that it is convenient if the local part where a bunch of stream data are present is randomly accessible from the stream processing processor 180. For example, this configuration can be used in application in which after a latter half of data is preliminarily produced within a randomly-accessible range, a former part of data is produced, or in which a stream is partially produced and outputting of the produced data is cancelled.

The stream buffer 130 is used while being divided into a plurality of areas, and is used while allowing the transfer channel of the DMA controller 120 to correspond to each area. Specifically, addresses ranging from the address specified in the buffer start address register 1201 of the DMA register set to the address just before the buffer end address register 1202 correspond to one area of the stream buffer 130. The stream buffer space 6130 is divided into spaces for transfer channels of DMA, and the areas of the stream buffer 130 used in the respective transfer channels are mapped to the respective divided spaces.

Focusing on an area of the stream buffer 130 assigned to one transfer channel, FIG. 9 shows how the area is mapped to the stream buffer space 6130. FIG. 9 focuses on a first buffer area 131 of the stream buffer space 6130. The address held by the buffer write address register 1203 or the buffer read address register 1204 of the DMA register set of the DMA transfer channel using the first buffer area 131 is converted and mapped so that the first buffer area 131 is located at the top of a first buffer map area 6131. In the case where the transfer channel is used for the input stream, the address held by the buffer read address register 1204 is used. In the case where the transfer channel is used for the output stream, the address held by the buffer write address register 1203 is used. By performing such an address conversion, the top portion of a range targeted for a process by the stream processing processor 180 at some point has always the same address, and a program operated by the stream processing processor 180 can be easily developed. In other words, since the stream buffer 130 has a function as an FIFO buffer, a physical address of the buffer area in the stream buffer 130 varies. Such an address conversion may be performed when an address operation of an access address where the stream processing processor 180 accesses the stream buffer 130 is performed. A buffer read address or a buffer write address that is necessary to offset at the time may be obtained from the DMA controller 120.

In the case where data are directly read or written from/into the stream buffer 130 by the stream processing processor 180 using the stream buffer space 6130, it is necessary to manage a buffer management pointer of the DMA transfer channel corresponding to the target buffer where the data are directly read or written by using a part of a program operated by the stream processing processor 180.

In the transfer channel where the input stream process is performed, it is necessary to confirm that necessary and sufficient data are already read into the stream buffer 130 before referring the data. The following data in the stream have to be read after all the processes which refer the data in the stream buffer 130 are completed. The buffer full flag 1293, the buffer write address register 1203, and the buffer read address register 1204 of the DMA transfer channel are used to confirm whether the data are already read. The next data in the stream is read when the value of the buffer read address register 1204 of the DMA transfer channel is updated by adding the length of data which are already referred. However, in the case of the value of the buffer read address register 1204 subsequent to the value of the buffer end address register 1202, the value is subtracted by the result of subtraction the value of the buffer start register 1201 from that of the buffer end address register 1202. The buffer full flag 1293 is updated at the same time the buffer read address register 1204 is updated.

In the transfer channel where the output stream process is performed, it is necessary to confirm that a necessary and sufficient space is spared in the stream buffer 130 before writing. After the writing process into the stream buffer 130 is completed, the data have to be write to the stream. The buffer full flag 1293, the buffer write address register 1203, and the buffer read address register 1204 of the DMA transfer channel are used to confirm whether a necessary and sufficient space is spared in the stream buffer 130. The stream is continuously written when the value of the buffer write address register 1203 of the DMA transfer channel is updated by adding the length of the data to be written. However, in the case of the value of the buffer write address register 1203 subsequent to the value of the buffer end address register 1202, the value is subtracted by the result of subtraction the value of the buffer start register 1201 from that of the buffer end address register 1202. The buffer full flag 1293 is updated at the same time the buffer write address register 1203 is updated.

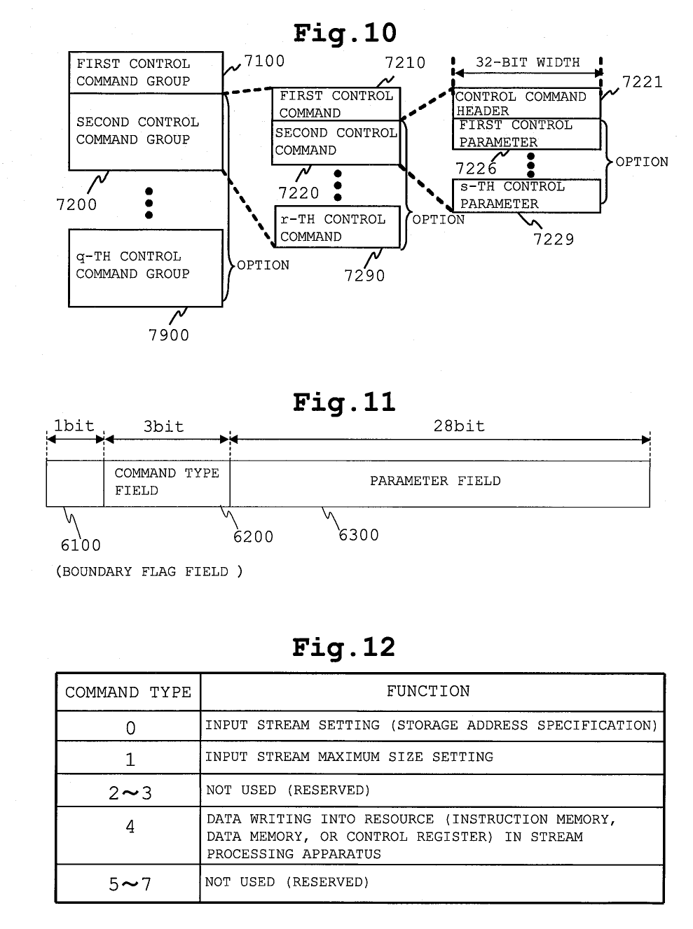

In FIG. 10, there is exemplified a configuration of the control stream 700. The control stream 700 includes one or more control command groups 7100 to 7900, and each control command group includes one or more control commands 7210 to 7290. Each control command includes a control command header 7221 and 0 or more control parameters 7226 following the control command header 7221. One control command group has control information corresponding to a process of one set of input streams to be simultaneously referred to at the time of the stream process. The arrangement of a plurality of control command groups allows plural sets of input streams to be continuously processed by the stream processing apparatus 100.

In FIG. 11, there is exemplified a field configuration of the control command header 7221. The control command header 7221 has a boundary flag field 6100, a command type field 6200, and a parameter field 6300.

The boundary flag field 6100 is a flag used for showing the last control command of one control command group. In the case of the last control command of one control command group, 1 is specified, and 0 is specified otherwise. The number of control commands configuring one control command group varies, so that the control stream analysis unit 150 refers to the boundary flag field 6100 to determine the last of one control command group.

The command type field 6200 is a field used for specifying a command type, and specifies a value for specifying the function of the control command. The control stream analysis unit 150 determines the content of a process and a parameter configuration included in the control command on the basis of the value of the command type field 6200.

The parameter field 6300 is a field used for storing a parameter configuring a command, and the meaning of the parameter field 6300 differs depending on the value of the command type field 6200.

In FIG. 12, there are exemplified relations between the values of the command type field 6200 and command functions.

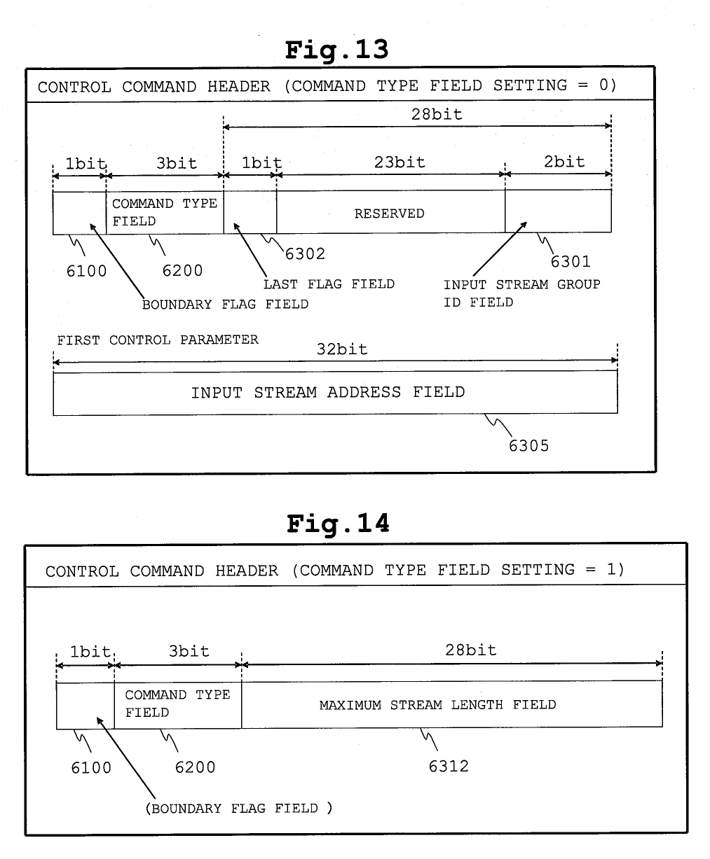

A command type 0 has a function of, when processing the stream corresponding to the control command group belonging to the command header, specifying an address into which the target input stream is stored. The control command header of the command type 0 has a configuration shown in FIG. 13. In the command type 0, 0 is specified in the command type field 6200. A last flag 6302 is a flag indicating that the control command group to which the control command header belongs is the last one of the control stream 700. If the control command group is the last, 1 is specified, and 0 is specified otherwise. Specifically, when 1 is specified in the boundary flag field of the control command of the command type 0 with 1 in the last flag 6302 or the following control command, the control command is handled as the last control command of the control stream 700.

A reserved area is an area being not used. An input stream group ID is specified in an input stream group ID field 6301. In the command type 0, it is necessary to specify a first control parameter 7226, and an input stream address field 6305 is present in the first control parameter 7226. In the input stream address field 6305, the address at which the target input stream is stored is specified. The address is an address in the address space shown in FIG. 3.

The input stream group ID is an identification number of each input stream, and is used when identifying each input stream in the case where one set of input streams to be simultaneously referred to in the stream process includes a plurality of input streams. When the control stream analysis unit 150 processes the control command, assignment of the DMA transfer channel used for inputting the input stream is determined, so that the stream processing processor 180 can correctly refer to the input stream to be referred to at the time of processing.

In the case where one set of input streams to be simultaneously referred to in the stream process includes a plurality of input streams, all input streams are specified by using a plurality of command types 0 in which the input stream group IDs are different from each other in one control command group. In the case where one set of input streams to be simultaneously referred to includes a single input stream, 0 is usually specified in the input stream group ID.

The control command header of a command type 1 has a configuration shown in FIG. 14. The command type 1 has a function of setting the maximum size of the input stream specified by the previous control command of the command type 0.

In the command type 1, “1” is specified into the command type field 6200. A maximum stream length field 6312 is a field for specifying the size limit of the input stream. A value set in the maximum stream length field 6312 is written by the control stream analysis unit 150 into the maximum offset address register 1207 existing in the DMA register set of the transfer channel of the corresponding input stream. By specifying the maximum stream length, a memory area can be limited for each input stream, and the memory can be protected. Further, even in the case where the process is not normally performed because a part of an input stream is corrupted and the last part of the input stream can not be determined, the DMA controller 120 notifies the stream processing processor 180 at the time of processing the input stream by a specified length or larger in the maximum stream length, so that it is possible to avoid the risk of not terminating the process.

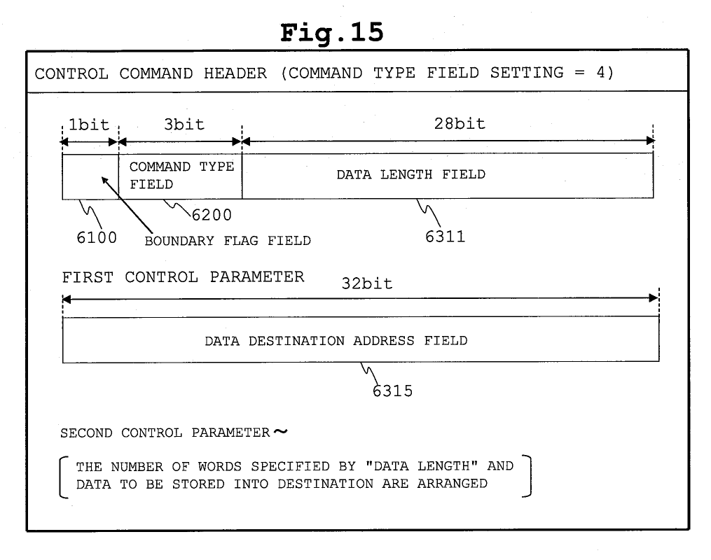

The control command header of a command type 4 has a configuration shown in FIG. 15. The command type 4 has a function of writing arbitrary data into the instruction memory 160, the data memory 170, and the control register 140.

In the command type 4, “4” is specified in the command type field 6200. The length of data to be written is specified in a data length field 6311. The length is specified as the number of words, each word having 32 bits. However, the unit of length specification may be changed in accordance with a system. In the command type 4, the first control parameter has a data destination address field 6315. In the data destination address field 6315, the address corresponding to the address space shown in FIG. 4 is specified as a data destination. However, in the case where the address is one corresponding to one of the double buffer spaces of the instruction memory 160 or the data memory 170, address conversion is performed by the control stream analysis unit 150, and one of the double buffer spaces in the address space shown in FIG. 4 is being used by the stream processing processor 180, so that it is controlled to access the other of the double buffer spaces. Accordingly, in the case where the data are written into the double buffer areas of the instruction memory 160 or the data memory 170 by the control command of the command type 4, the address having a smaller number may be specified in the data destination address field.

Data to be written in the command type 4 are sequentially stored by the number specified in the data length field 6311 in the second control parameter and the control parameters subsequent to the second control parameter.

Setting of a destination of the output stream is also performed using the control command of the command type 4. In the command type 4, a parameter can be written in an arbitrary area of the data memory 170. Accordingly, if an address where the destination address of the output stream is stored in the data memory 170 is determined in advance, the destination address is written into the address using the control command of the command type 4, and the DMA control register existing in the DMA controller 120 is set by referring to the destination address with a program operated by the stream processing processor 180, the output stream can be written into the specified address.

The setting of the destination of the output stream and the DMA control register is performed by the program operated by the stream processing processor 180, so that the degree of freedom is high in an output stream outputting method. For example, the processing results relating to one set of plural input streams to be simultaneously referred to can be integrated into one output stream, or one input stream can be output by being divided into plural output streams for each type of information included in the stream. In addition, the processing results of the input streams specified by different control command groups can be output as one continuous output stream.

The division of one input stream into plural output streams for each type of information included in the stream is effective in a decoding process of image codec such as MPEG-2. At the time of decoding of the image codec, a process of converting a coefficient such as an iDCT process and a process of reading a reference image from an already-decoded image on the basis of a motion vector can be executed in parallel. The coefficient such as the iDCT process and the motion vector information are included in the input stream. Accordingly, if these parameters are converted into formats which are easily used in the iDCT process and the motion vector process by the stream processing apparatus 100, and the respective parameters are output as different streams, the iDCT process and the process of reading the reference image on the basis of the motion vector can be easily executed in parallel.

The input stream can not be started to be processed by the stream processing processor 180 during a period from the time when data are read from the memory 350 after the corresponding transfer channel is started to be operated in the DMA controller 120 to the time when the read content is written into the stream buffer 130. However, the output stream can be written into the stream buffer 130 after the DMA controller 120 is set. Accordingly, even if the setting of the DMA control register is performed for the output stream by the stream processing processor 180, the processing performance of the stream processing apparatus 100 is less affected.

In FIG. 16, there is exemplified operation timing of the stream processing apparatus 100. The entire operation of the stream processing apparatus 100 will be described using FIG. 16.

Before using the stream processing apparatus 100, an initializing process of the stream processing apparatus 100 is performed by the host processor 200 in the first place (TR1). It is necessary to assign the area of the stream buffer 130 to the DMA transfer channel by setting the DMA control register. In addition, an initial program and a subroutine that is commonly used in performing the stream process are written into the instruction memory 160, and a parameter that is commonly used is written into the data memory 170, if needed.

Next, the control stream 700 necessary for processing the input stream stored in the memory 350 is generated by the host processor 200. If the generation of the control stream 700 is completed, the address of the control stream 700 is written into a register for specifying the initial address of the control stream 700 existing in the control register 140. This operation allows the stream processing apparatus 100 to start. When the address of the control stream 700 is written into the register for specifying the initial address of the control stream 700, the address is once written into the control stream address queue 155. If the control stream analysis unit 150 does not process the control stream 700 in a state where one or more addresses are held in the control stream address queue 155, the control stream analysis unit 150 initializes the DMA register set corresponding to the DMA transfer channel of the control stream 700, starts to read the control stream 700, and starts to process the control stream 700 (TR2).

The control stream analysis unit 150 proceeds to process in accordance with the control stream 700, and sets the DMA transfer necessary for reading the input stream at the time information necessary for reading the input stream is prepared to start reading of the input stream (TR3). Then, the stream process performed by the stream processing processor 180 is started at the time all the processes of one control command group are completed (TR4). At this time, information of the DMA transfer channel being used for reading the input stream is transmitted to the stream processing processor 180, and information of the DMA transfer channel available for outputting the output stream is also transmitted to the stream processing processor 180. In order to simultaneously output a plurality of output streams if needed, the predetermined number of channels as the DMA transfer channels available for outputting the output streams in the stream processing apparatus 100 is transmitted to the stream processing processor 180 as the DMA transfer channels available for outputting the output streams.

At the same time when the stream process is started by the stream processing processor 180, the control stream analysis unit 150 starts to process the next control command group (TR5). At this time, assignment of the double buffer areas used for writing into the instruction memory 160 and the data memory 170 with the control command is inverted so as not to affect on the process performed by the stream processing processor 180. By proceeding to process the next control command group, a program necessary for the process of the next input stream is written into the instruction memory 160, and a parameter is written into the data memory 170. In addition, setting of a register for DMA control necessary for reading the next input stream is also performed. At this time, DMA transfer channels other than those being used for reading the current input stream and those available for outputting the output stream, which are notified to the stream processing processor 180, are used.

At the time the process of the control command group corresponding to the next input stream is completed, the control stream analysis unit 150 starts the DMA transfer channel to be used for reading the next input stream, and starts the input stream in advance (TR6). At this time, in the case of a process of referring to a plurality of input streams, all the necessary input streams are read in advance.

At the time the process of the next control command group is completed and the process of the input stream executed by the stream processing processor 180 is completed, the control stream analysis unit 150 inverts the assignment of the double buffer areas of the instruction memory 160 and the data memory 170 viewed from the stream processing processor 180, notifies the stream processing processor 180 of the DMA transfer channel being used for reading the next input stream, and notifies the stream processing processor 180 of the DMA transfer channel available for outputting the output stream at the time of processing the next input stream. Then, the stream processing processor 180 is started again. At the time the stream processing processor 180 is started, reading of the initial portion of the input stream is completed and a program and a parameter are prepared, so that the stream processing processor 180 can immediately start the process (TR7).

Thereafter, the same process is repeated until the process of the last control command group of the control stream 700 is completed, so that the stream processing processor 180 can process without stopping.

During the operation of the stream processing apparatus 100, the next control stream 700 can be specified by the control stream address queue 155. It is necessary to generate the control stream 700 in a state where the input stream is stored in the memory 350. Even when the stream processing apparatus 100 is being operated, a new input stream is input from the input/output apparatus 400 to be stored into the memory 350 in some cases. In such a case, if the next control stream 700 is generated by the host processor 200 and is written into the register for specifying the initial address of the control stream 700 existing in the control register 140 even when the stream processing apparatus 100 is being operated, the address of the next control stream 700 can be stored into the control stream address queue 155, and the control stream analysis unit 150 can continuously process a plurality of control streams 700.

In the above description, the stream processing apparatus 100 is shown as one apparatus. However, the stream processing apparatus 100, the host processor 200, the memory control apparatus 300, and the input/output apparatus 400, and the bus 500 may be realized as a semiconductor device obtained by integrating them onto one semiconductor substrate.

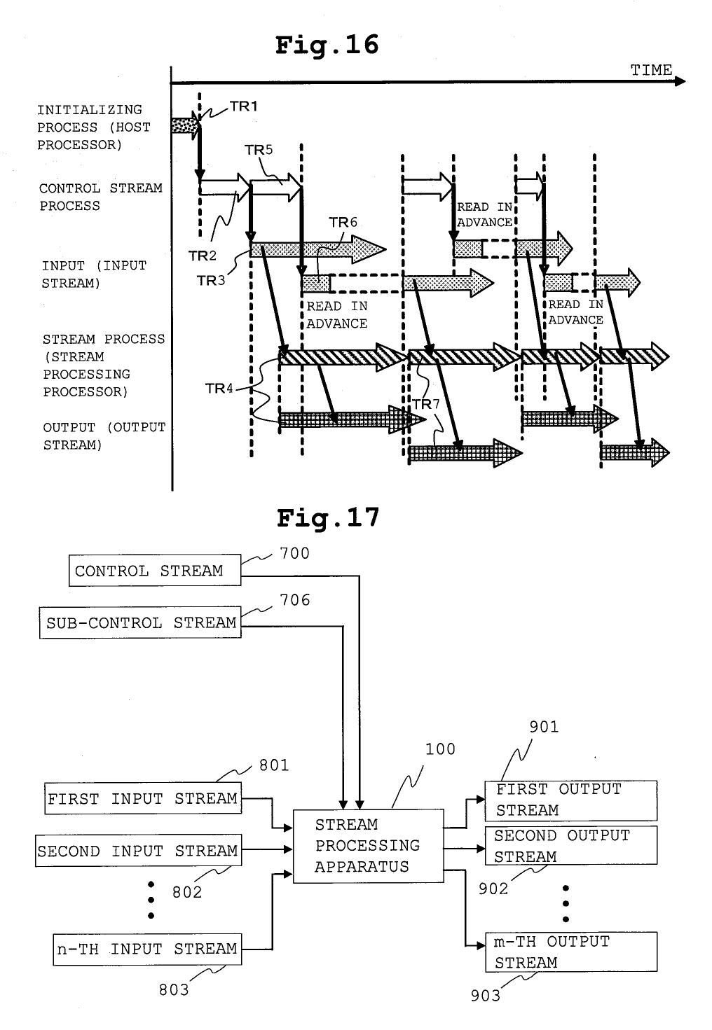

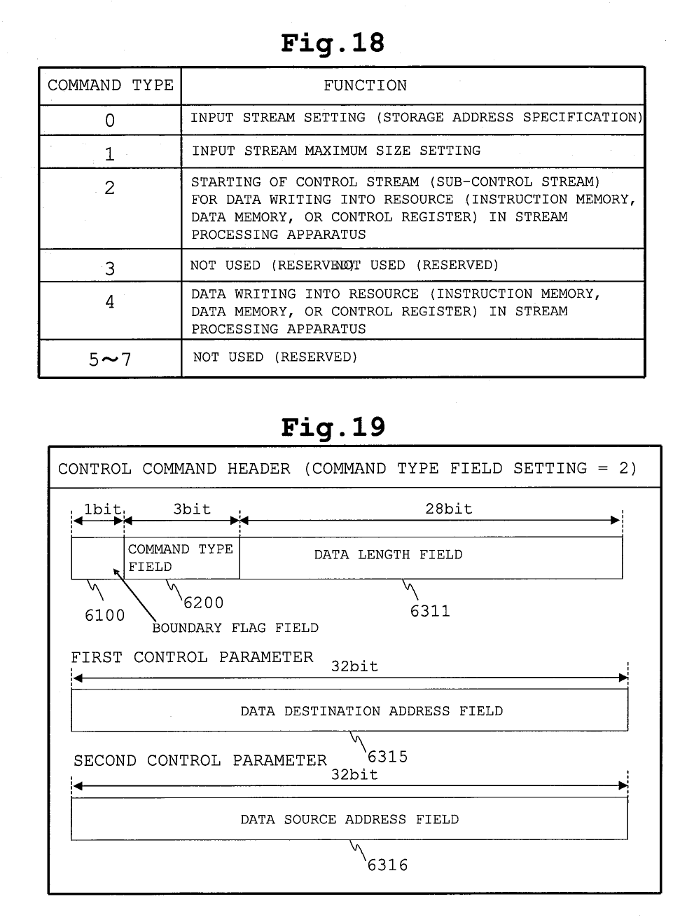

In FIG. 17, there is exemplified an example in which the function of the stream processing apparatus 100 is extended. In FIG. 17, the stream processing apparatus 100 can handle a sub-control stream 706 in addition to the streams of input/output targets in FIG. 1. Therefore, the stream processing apparatus 100 can use the command types shown in FIG. 18 in the control stream 700. In order to handle the sub-control stream 706, a command type 2 is added to the command available in the control stream 700 for the stream processing apparatus 100. The command type 0, the command type 1, and the command type 4 are the same.

The control command header of the command type 2 has a configuration shown in FIG. 19. The command type 2 has a function of writing arbitrary data into the instruction memory 160, the data memory 170, and the control register 140, as similar to the command type 4. The data to be written are stored in the control command as a control parameter in the command type 4. However, the data to be written are read as the sub-control stream 706 in the command type 2. Specifically, it is necessary in the command type 2 to prepare an area for storing the sub-control stream 706 in the memory 350 and to store a data string to be written into the area.

In the command type 2, 2 is specified in the command type field 6200. The length of data to be written is specified in the data length field 6311. The length is specified as the number of words, each word having 32 bits. In the command type 2, the first control parameter has the data destination address field 6315. In the data destination address field 6315, the address corresponding to the address space shown in FIG. 4 is specified as a data destination. However, in the case where the address is one corresponding to one of the double buffer spaces of the instruction memory 160 or the data memory 170, address conversion is performed by the control stream analysis unit 150 so as to control the area to be not being used by the stream processing processor 180 in the address space shown in FIG. 4. Accordingly, in the case where the data are written into the double buffer areas of the instruction memory 160 or the data memory 170 by the control command of the command type 2, if the address having a smaller number is specified in the data destination address field, the process is performed so as not to affect on the operation of the stream processing processor 180.

In the command type 2, the second control parameter has a sub-control stream address field 6313. An initial address at which the sub-control stream 706 is stored is specified in the sub-control stream address field 6313. This address is the address in the address space shown in FIG. 3.

The content of the sub-control stream 706 is a data string to be written into the instruction memory 160, the data memory 170, or the control register 140 in the command type 2. Accordingly, it is necessary to prepare the sub-control streams 706 corresponding to the types of programs which are written into the instruction memory 160 using the command type 2, or corresponding to a bunch of data to be written into the data memory 170.

When the control stream analysis unit 150 processes the control command of the command type 2, the control stream analysis unit 150 initializes and starts the DMA transfer channel assigned for reading the sub-control stream 706, and the content of the sub-control stream 706 is transferred to the instruction memory 160, the data memory 170, or the control register 140 by the DMA controller 120. After waiting for completion of the transfer of the sub-control stream 706, the control stream analysis unit 150 processes the next control command.

Due to the data transfer of the sub-control stream 706, it is necessary to have one more DMA transfer channel as compared to the case of FIG. 1. Accordingly, it is also necessary to have one more DMA register set as compared to the case of FIG. 1.

Using the command type 2 makes it easy, especially, to handle a program to be written into the instruction memory 160, as compared to generation of the control stream 700 only with the command type 4. In general, the format of an input stream to be handled is complied with a specification and a standard, so that the type of a program necessary in the stream process can be limited. In the case of using the command type 4, it is necessary to generate the control stream 700 by, for example, copying a data string corresponding to a program in the command stream for each control command group. However, in the case of using the command type 2, if a necessary program is stored in a predetermined area in advance, the initial address at which the program is stored may be specified by the command type 2. Accordingly, it is not necessary to copy the data string corresponding to the program, and the process of the host processor 200 and access to the memory 350 can be reduced.

The stream processing apparatus of the present invention can be applied to generation of a stream obtained by coding an image, sound, and the like, and to decoding of a stream obtained by coding an image, sound, and the like. There is a coding standard in each of an image and sound, and there are a plurality of coding standards in each of an image and sound. The stream processing apparatus of the present invention can be also used for encryption of various data streams containing a stream obtained by coding an image and sound and a decryption process of the encrypted data stream. There are many devices such as a digital television and a DVD capable of handling image/sound streams and encrypted streams. The stream processing apparatus in these devices needs to perform stream processes with various standards, and it is necessary to change a processing program and a parameter in accordance with the standard to which the stream belongs. The stream processing apparatus of the present invention allows the stream processing processor to continuously and efficiently process the streams in various formats while changing the program and the parameter, and many stream processes can be performed using the stream processing processors with the same performance.

The invention achieved by the inventor has been described in detail on the basis of the embodiment. However, it is obvious that the present invention is not limited to the embodiment, but can be variously changed in a range without departing from the gist of the invention.

What is claimed is:

1. A stream processing apparatus which inputs a data stream to perform an arithmetic process and outputs the result as a data stream, the stream processing apparatus comprising:
a buffer memory; and
a processor,
wherein information necessary for a stream process is input to the buffer memory as a control stream, the control stream contains information on where to obtain the data stream to be input and a parameter necessary for the arithmetic process of the data stream, the data stream is input to the buffer memory in accordance with the information on where to obtain the data stream, and the processor performs the arithmetic process for the data stream input to the buffer memory on the basis of the parameter of the control stream.

2. The stream processing apparatus according to claim 1, comprising a register which specifies a location where the control stream is stored.

3. The stream processing apparatus according to claim 1, comprising a transfer control apparatus which transfers the control stream and the data stream to the buffer memory from the outside of the stream processing apparatus.

4. The stream processing apparatus according to claim 3, comprising a control unit which analyzes the control stream to obtain the parameter and the information on where to obtain the data stream, and sets transfer control conditions to the transfer control apparatus.

5. The stream processing apparatus according to claim 4, comprising a data memory to which the parameter is transferred and which is accessible by the processor.

6. The stream processing apparatus according to claim 5,
wherein the control unit obtains information on an arithmetic procedure from the control stream, the stream processing apparatus includes an instruction memory to which the obtained information on the arithmetic procedure is transferred and which is accessible by the processor, and the processor performs the arithmetic process using the information on the arithmetic procedure read from the instruction memory.

7. The stream processing apparatus according to claim 5,
wherein the control stream contains information on starting of a sub-control stream, the sub-control stream contains a parameter necessary for a process of the data stream, the control unit sets the transfer control conditions to the transfer control unit in accordance with the content of the control stream so as to transfer the sub-control stream to the buffer memory, and the processor performs the arithmetic process on the basis of the parameter of the sub-control stream transferred to the buffer.

8. The stream processing apparatus according to claim 6,
wherein the control stream contains information on starting of a sub-control stream, the sub-control stream contains the information on the arithmetic procedure necessary for a process of the data stream, the control unit sets the transfer control conditions to the transfer control unit in accordance with the content of the sub-control stream so as to transfer the sub-control stream to the buffer memory, and the processor performs the arithmetic process on the basis of the information of the arithmetic procedure transferred to the buffer.

9. The stream processing apparatus according to claim 1,
wherein in a process of one input data stream, the result is output while being divided into a plurality of data streams.

10. The stream processing apparatus according to claim 1, referring to a plurality of input streams, performing the arithmetic process by referring to the input streams, and outputting the result of the arithmetic process.

11. The stream processing apparatus according to claim 1,
wherein the processor performs a stream process in accordance with the arithmetic procedure, the buffer memory temporarily stores the input data stream and the data stream to be output, and the processor can randomly access the buffer memory.

12. The stream processing apparatus according to claim 1,
wherein the processor performs a stream process in accordance with the arithmetic procedure, the stream processing apparatus includes a data memory for storing data to be written or read by the processor, the data memory can perform an address conversion process when being accessed from the processor, and the address conversion is a process in which when a process of one data stream is completed and a process of the next data stream is started, logical addresses mapped to a memory area where one data stream is stored and a memory area where the other data stream is stored are switched to each other.

13. The stream processing apparatus according to claim 1,
wherein the processor performs a stream process in accordance with the arithmetic procedure, the stream processing apparatus includes an instruction memory for storing a program showing the arithmetic procedure of the processor, the instruction memory can perform an address conversion process when being accessed from the processor, and the address conversion is a process in which when a process of one data stream is completed and a process of the next data stream is started, logical addresses mapped to a memory area where the program showing the arithmetic procedure for one data stream is stored and a memory area where the program showing the arithmetic procedure for the next data stream is stored are switched to each other.

14. A stream processing apparatus which inputs a data stream to perform an arithmetic process and outputs the result as a data stream, the stream processing apparatus comprising:
a buffer memory;
a data transfer control apparatus which is used for data transfer control between the buffer memory and the outside of the stream processing apparatus; and
a processor which is used for an arithmetic process of the data stream stored in the buffer memory,
wherein the data transfer control apparatus transfers the data stream to the buffer memory on the basis of information on where to obtain the data stream held by a control stream stored in the buffer memory, and the processor performs the arithmetic process for the data stream in the buffer memory on the basis of a parameter necessary for the arithmetic process of the data stream held by the control stream transferred to the buffer memory, and
wherein the data transfer control apparatus controls data transfer of the data stream and the control stream between the outside of the data transfer control apparatus and the buffer memory in parallel to the arithmetic process by the processor for the data stream in the buffer memory.

15. The stream processing apparatus according to claim 14, further comprising a control unit which performs control on the basis of an analysis result of the control stream stored in the buffer memory,
wherein the control unit sets transfer conditions to the data transfer control apparatus on the basis of the information on where to obtain the data stream held by the control stream.

16. The stream processing apparatus according to claim 14, further comprising a data memory into/from which data can be written or read by the processor,
wherein the control unit sets a parameter necessary for the arithmetic process of the data stream held by the control stream to the data memory.

17. The stream processing apparatus according to claim 14, further comprising a data memory into/from which data can be written or read by the processor,
wherein the data memory can perform an address conversion process when being accessed from the processor, and the address conversion is a process in which when a process of one data stream is completed and a process of the next data stream is started, logical addresses mapped to a memory area where one data stream is stored and a memory area where the other data stream is stored are switched to each other.

18. The stream processing apparatus according to claim 14, further comprising an instruction memory for storing a program showing the arithmetic procedure of the processor,
wherein the instruction memory can perform an address conversion process when being accessed from the processor, and the address conversion is a process in which when a process of one data stream is completed and a process of the next data stream is started, logical addresses mapped to a memory area where the program showing the arithmetic procedure for one data stream is stored and a memory area where the program showing the arithmetic procedure for the next data stream is stored are switched to each other.

19. A stream processing method in which an arithmetic process is performed for a data stream to output the result as a data stream, the stream processing method comprising the steps of:
preparing, as information necessary for the stream process, information on where to obtain the data stream to be processed and one or more control streams each containing a parameter necessary for a process of the data stream;
referring to the data stream in accordance with the information on where to obtain the data stream of the prepared control stream; and
performing an arithmetic process by referring to the parameter of the prepared control stream.

20. A data processing system comprising:
a stream processing apparatus which inputs a data stream to perform an arithmetic process and outputs the result as a data stream;
a memory in which a control stream and the data stream are stored as information necessary in a stream process for the data stream; and
a host processor which controls the memory and the stream processing apparatus,
wherein the control stream contains information on where to obtain the data stream to be input and a parameter necessary for the arithmetic process of the data stream, and
wherein the stream processing apparatus includes a buffer memory and a processor, inputs the control stream from the memory to the buffer memory, and inputs the data stream to the buffer memory in accordance with the information on where to obtain the data stream held by the input control stream, and the processor performs the arithmetic process for the data stream input to the buffer memory on the basis of the parameter of the control stream.

21. The data processing system according to claim 20,
wherein the host processor performs control to store the control stream and the data stream into the memory, and
wherein the stream processing apparatus includes a transfer control apparatus which transfers the control stream and the data stream from the memory to the buffer memory.

22. The data processing system according to claim 20, being formed over one semiconductor substrate as a semiconductor device.
